(19) United States
(12) Patent Application Publication
(10) Pub. No.: US 2026/0288508 A1
(43) Pub. Date: Sep. 24, 2026

(54) Managed Hypervisor

(71) Applicant: IGEL Technology GmbH, Bremen (DE)

(72) Inventors: Jason Mafera, Francestown, NH (US); Matthias Stefan Haas, Schwabmünchen (DE); Christina Jenna Mueller, Landsberg am Lech (DE)

(21) Appl. No.: 19/576,842

(22) Filed: Mar. 24, 2026

Related U.S. Application Data
(60) Provisional application No. 63/776,937, filed on Mar. 24, 2025.

(51) Int. Cl. G06F 9/455

(52) U.S. Cl. CPC G06F 9/45558; G06F 2009/45583; G06F 2009/45587

(57) ABSTRACT

A managed hypervisor is described. An endpoint device downloads and installs a managed hypervisor after receipt of configuration instructions from a management server. The managed hypervisor uses type 1 kernel components to provide direct hardware access and acceleration and uses type 2 client-based components to interact with a virtual machine and provide a visualization layer. The type 2 client-based components leverage the type 1 kernel components for hardware and platform compatibility and hardware acceleration for performance enhancements. The endpoint device downloads a guest operating system image after receipt of configuration instructions for a virtual machine from the management server. A virtual machine with the guest operating system is created using the managed hypervisor. Writes by the guest operating system are redirected to a data structure in memory of the endpoint device.

### CROSS-REFERENCE TO RELATED APPLICATIONS

This application claims the benefit of U.S. Provisional Application No. 63/776,937, filed Mar. 24, 2025, which is hereby incorporated by reference.

### FIELD

Embodiments of the invention relate to the field of virtualization; and more specifically, to a managed hypervisor.

### BACKGROUND

Information Technology (IT) and Operational Technology (OT) networks are converging. Traditionally, OT networks have been physically isolated from other networks such as the internet and other unsecured local networks. For instance, there may be no wired or wireless connections between the secured network and any other network where the only way to access the network is through physical means such as the manual transfer of data using a removable drive. However, with the convergence of IT and OT networks, OT devices may be exposed to the internet or other unsecured local networks.

OT devices often run on legacy, or outdated, operating systems for reasons such as stability, compatibility, and regulatory concerns. For instance, OT systems, such as those controlling industrial equipment, utilities, and manufacturing processes, prioritize stability and reliability. These systems are designed to run continuously with minimal downtime. Upgrading the operating system can introduce instability or require a period of adjustment that could disrupt continuous production processes. Further, many OT systems rely on software and applications specifically designed for older operating systems due to specialized requirements such as hardware that may not be compatible with newer operating systems. Upgrading the OS could require significant changes to or complete rewrites of these critical applications, which is costly and time-consuming. Further, OT devices may have a longer lifecycle than IT devices. Many OT environments, such as those in critical infrastructure or that involve safety-critical operations, require certification and testing. Updating an operating system could necessitate re-certification, a process that can be costly and time intensive.

Virtualization allows a virtual machine to be run on a device. A hypervisor creates and runs the virtual machine on the device. Hypervisors are categorized into two main types, type 1 and type 2. Type 1 hypervisors, sometimes called bare-metal hypervisors, run directly on the hardware of the host without a host operating system. This enables efficient resource utilization with minimal performance overhead. Type 1 hypervisors do not have a presentation layer. Type 2 hypervisors, sometimes called hosted hypervisors, run on top of the operating system of the host device. Type 2 hypervisors are typically easier to install and have increased flexibility compared to Type 1 hypervisors, at the cost of lower performance due to the additional operating system abstraction. A type 2 hypervisor typically includes a presentation layer.

### BRIEF DESCRIPTION OF THE DRAWINGS

The invention may best be understood by referring to the following description and accompanying drawings that are used to illustrate embodiments of the invention. In the drawings:

FIG. 1 illustrates a system for a managed hypervisor according to an embodiment.

FIG. 2 illustrates a flow diagram for configuring and deploying a managed hypervisor according to an embodiment.

FIG. 3 is a flow diagram that illustrates exemplary operations performed at an endpoint device for executing a managed hypervisor according to an embodiment.

FIG. 4 is a flow diagram that illustrates exemplary operations performed at an endpoint device for responding to instructions to manage a virtual machine according to an embodiment.

### DESCRIPTION OF EMBODIMENTS

A managed hypervisor is described. The managed hypervisor is deployed to an endpoint device that is running a secure operating system in read-only mode. The guest operating system is deployed as an encrypted image. The encrypted image is stored on a persistent disk partition of the endpoint device that is dedicated for guest operating system image deployment. The endpoint device decrypts the encrypted image and may boot the guest operating system using the managed hypervisor.

The managed hypervisor operates as a hybrid hypervisor that uses type 1 (bare metal) and type 2 (hosted) components. The managed hypervisor uses type 1 kernel components to run directly within the kernel to provide, among other things, direct hardware access and acceleration. The managed hypervisor uses type 2 client-based components that leverage the type 1 components for hardware and platform compatibility, and hardware acceleration for performance enhancements. The type 2 client-based components are used to interact with a virtual machine and provide a visualization layer. The type 2 client-based components may support full function mode or kiosk mode.

In an embodiment, when the managed hypervisor is running, write operations by the guest operating system are redirected to a data structure (e.g., a copy-on-write snapshot volume) in memory of the endpoint device rather than to the original base image. The memory may be volatile memory such as Random Access Memory (RAM), non-volatile memory such as disk-based or solid-state storage devices such as hard disk drives, solid-state drives, flash storage, or other persistent storage devices, or a combination thereof. No data is written to the original base image in this embodiment. In one embodiment these write operations are not persisted while in another embodiment these write operations are persisted.

In an embodiment where these write operations are not persisted, in the event the virtual machine, the hypervisor, or the endpoint device is turned off, the writes stored in the data structure (e.g., the snapshot volume) will be discarded and not persisted, thereby resetting the guest operating system to the original state represented by the base image. This allows for full reset capability to a known good state (e.g., the base image) during a shutdown of the virtual machine or the endpoint device. This ensures that any changes or malicious code introduced during an active session are discarded when the virtual machine is turned off

In an implementation where the write operations are redirected to a snapshot volume stored in non-volatile memory, when the virtual machine is turned off, the snapshot volume is discarded. If this operation is interrupted and/or the endpoint device unexpectedly powers down (e.g., during a power loss event), the snapshot volume may remain present in the non-volatile memory but will be discarded when the virtual machine is turned back on.

In an implementation where the write operations are redirected to a snapshot volume stored in volatile memory, when the virtual machine is turned off or the endpoint device is turned off (which includes a power loss event), the write operations are discarded from the volatile memory.

By redirecting write operations to a snapshot volume that is not persisted, any suspected malware can be eliminated simply by shutting down the virtual machine or endpoint device, thereby restoring the system to a known good state (the original base image).

In another embodiment where persistence is desired, in the event the virtual machine, the hypervisor, or the endpoint device is shut down, the write information stored in the data structure (e.g., the snapshot volume) in memory is persisted on the endpoint device. For instance, if the data structure is implemented in volatile memory, the data structure is written to a persistent storage device of the endpoint device. If the data structure is implemented in non-volatile memory, the data structure is kept as persistent. In this embodiment, data is allowed to be written during the active session and persisted across shutdowns. The persistence of the data (whether it is persisted or not) can be configured based on policy in an embodiment.

In some implementations, the original base image is mutable. In such an implementation, write operations by the guest operating system may be written directly to the base image rather than being redirected to a snapshot volume, or alternatively may be redirected to a snapshot volume. Thus, modifications made during execution of the virtual machine are persisted and therefore remain available after the virtual machine is shut down and subsequently started again. This embodiment may be used, for example, where persistence of changes to the guest operating system image is desired.

In some implementations, policy received from the management server may specify whether the virtual machine is to operate in (i) a non-persistent mode in which writes are redirected to a temporary data structure and discarded upon shutdown, or (ii) a persistent mode in which writes are persisted, which can be to the original base image and/or to non-volatile memory of the endpoint device.

The managed hypervisor is managed from a central location. This includes managing deployment, startup, shutdown, and/or refresh of a virtual machine. For instance, a management server may provide an interface to allow for the targeted deployment and control of the managed hypervisor to endpoint devices. This interface allows the owner or administrator of the endpoint devices to manage which virtual machines are deployed to which endpoint devices and their run state (e.g., start, shutdown, refresh) and associated configuration. The interface allows a group of endpoint devices to be targeted and/or individual endpoint devices to be targeted. As an example, in an embodiment where writes are only to a snapshot volume in the endpoint device in a non-persistence mode, if malware is suspected to be on an endpoint device or a group of endpoint devices, the owner or administrator may use the interface to send a shutdown or refresh command to those endpoint device(s) to cause any writes, and thus any malware, to be discarded from the snapshot volume thereby eliminating any suspected malware.

The managed hypervisor is deployed to the endpoint device(s) that have been targeted to run the managed hypervisor. For instance, the management server (or other deployment server of the service) transmits the managed hypervisor to the targeted endpoint device(s). As an example, the management server may assign a configuration profile to the targeted endpoint device(s) that specifies the managed hypervisor deployment, including a location (e.g., URL) to download the managed hypervisor. An endpoint device that receives this configuration profile will download the managed hypervisor from the source and install the managed hypervisor. The managed hypervisor may be cryptographically signed, and the endpoint device may verify the signature prior to installation. For example, a management client running on the endpoint device receives the configuration profile from the management server that specifies the managed hypervisor deployment. The management client will cause the managed hypervisor to be downloaded from the source specified in the configuration profile (e.g., from the management server or from another deployment server). The management client will cause the managed hypervisor to be installed on the endpoint device.

The management client running on the endpoint device receives configuration from the management server related to a guest operating system operating as a virtual machine controlled by the managed hypervisor. The configuration includes a location (e.g., URL) of where to download the guest operating system image from an image store. The guest operating system image includes the guest operating system. The guest operating system image may be encrypted at rest at the image store. The configuration may include a memory setting (e.g., the maximum memory to be allocated to the virtual machine), a number of virtual CPUs to be allocated to the virtual machine, the networking mode for the virtual machine (e.g., isolated, Network Address Translation (NAT), direct, host-only, MacVTap), whether the virtual machine is to automatically start during the startup process of the endpoint device, whether a shortcut to the virtual machine is to be placed on the desktop of the host operating system, whether a shortcut to the virtual machine is to be placed on the start menu of the host operating system, and/or whether the virtual machine is to start in kiosk mode where user access is limited to only the guest operating system or application running on the virtual machine. In some implementations, the received configuration may supplement or override selected parameters of a virtual machine configuration that was initially created for the virtual machine. For example, when the virtual machine is initially prepared by an administrator, the administrator may generate a virtual machine configuration including virtual machine parameters and upload the virtual machine configuration and one or more corresponding disk images to deployment infrastructure. At a later time, the management system may create one or more deployment configurations assigned to one or more endpoint devices, where a deployment configuration overrides selected parameters of the virtual machine configuration for the assigned endpoint device or group of endpoint devices.

The virtual machine configuration may further specify one or more access restrictions for the virtual machine and/or the guest operating system. In some implementations, the access restrictions are centrally defined and enforced by the management server 160 rather than by an end user of the endpoint device 105 or by the guest operating system itself. The access restrictions may determine which users, administrator identities, endpoint devices, and/or groups of endpoint devices are permitted to access, launch, use, or manage the virtual machine, under what conditions such access is permitted, and what capabilities are available during such access. Thus, the access restrictions may centrally control availability of the virtual machine, conditions for use of the virtual machine, and capabilities made available through the virtual machine, without requiring the end user or the guest operating system to define such restrictions.

In an embodiment, the guest operating system image is created with a creation tool provided by the service of the managed hypervisor. This creation tool may be used by the administrator or owner of the endpoint device. The creation tool includes managing the encryption of the guest operating system image. The guest operating system image may be stored at a remote location that is defined by the administrator or owner of the endpoint device.

For startup management, the management server may provide an interface to allow for direct command and control of the startup process of the virtual machine(s). For example, the management server may be used to send an instruction to an endpoint device to start a virtual machine. As another example, the management server may be used to instruct an endpoint device to automatically start the virtual machine during system startup. As another example, the management server may be used to instruct an endpoint device to automatically start a virtual machine in kiosk mode and/or to automatically start during system startup. The interface allows an administrator to target one or more group(s) of endpoint devices and/or one or more individual endpoint devices for such a startup instruction.

For shutdown management, the management server may provide an interface to allow for direct command and control of the shutdown process of the managed hypervisor. For example, the management server may be used to send an instruction to the endpoint device to shutdown the managed hypervisor, the virtual machine, the guest operating system, and/or the endpoint device itself. The interface allows an administrator to target one or more group(s) of endpoint devices and/or one or more individual endpoint devices for such a shutdown instruction.

For refresh management, the management server may provide an interface to allow for direct command and control of the refresh process of the managed hypervisor. For example, the management server may be used to send an instruction to the endpoint device to reboot the virtual machine and/or the endpoint device itself. The interface allows an administrator to target one or more group(s) of endpoint devices and/or one or more individual endpoint devices for such a refresh instruction. As described above, in an embodiment, if the write operations by the guest operating system are written to a data structure in memory of the endpoint device, upon a reboot of the virtual machine, the hypervisor or the endpoint device, all data stored in the memory is discarded and not persisted. This allows for a full reset capability of the endpoint device to a known good state (e.g., the base guest operating system image).

Embodiments described herein have the speed and performance of a type 1 bare metal hypervisor and the flexibility of the type 2 hosted hypervisor for the user presentation layer. In addition, embodiments allow for central management and control of the access, security, deployment, and user workflow experience without requiring or allowing user control of the virtual machine itself.

In contrast to server-centric virtualization deployments in which multiple virtual machines are typically hosted on one or more centralized servers, embodiments described herein may deploy and manage one or a small number of virtual machines on each of a large population of endpoint devices from a central management system. For example, the management server may be used to configure, deploy, start, shutdown, reboot, refresh, and otherwise manage managed hypervisors and corresponding virtual machines across numerous distributed endpoint devices, including endpoint devices located remotely from the administrator or owner. This architecture enables large-scale deployment and control of virtualized guest operating systems at the edge, rather than consolidating virtual machines in a server environment, while still allowing centralized policy enforcement, configuration management, and lifecycle control on a per-device or per-group basis.

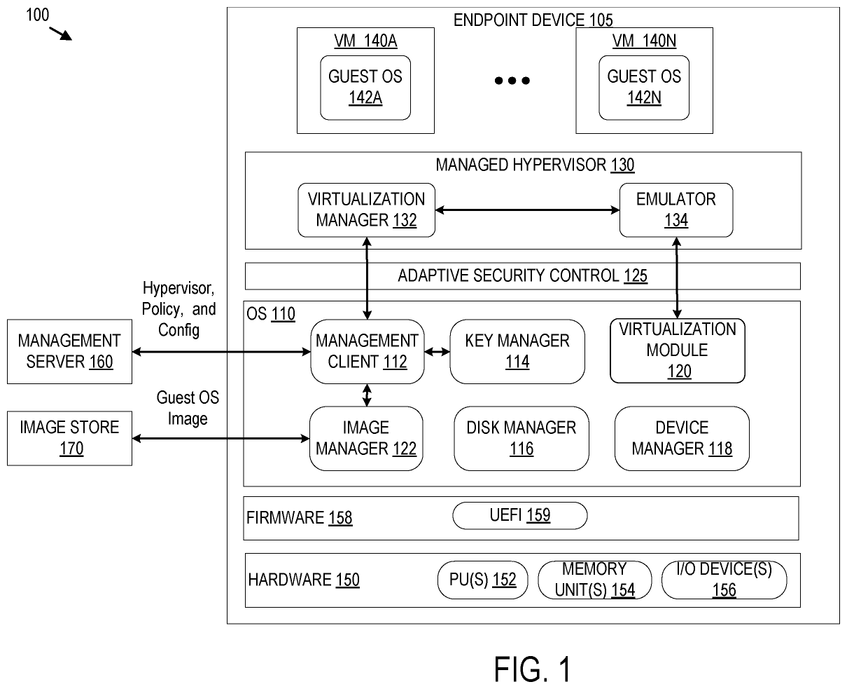

FIG. 1 illustrates a system for a managed hypervisor according to an embodiment. The system 100 includes an endpoint device 105, a management server 160, and an image store 170. The endpoint device 105 is a computing device which can be an IT device or an OT device. For instance, the endpoint device 105 can be a thin client, personal computer, mobile device, tablet computer, IoT device, industrial/manufacturing device (e.g., an industrial PC, a human-machine interface (HMI) device, a SCADA workstation, a PLC programming station, a CNC machine controller, a manufacturing execution system (MES) terminal, a robotics control station, an operator workstation, an assembly line workstation, an industrial barcode scanner station, etc.), a healthcare device (e.g., a patient monitoring system, a medical imaging workstation, a ventilator control interface, an infusion pump controller, a dialysis machine interface, a surgical robot console, an MRI scanner, a CT scanner, an x-ray machine, etc.), a building/facility management device (e.g., an HVAC control panel, an elevator diagnostic terminal, a refrigeration unit controller, a temperature control station, etc.), a retail/financial device (e.g., an automated teller machine, a point-of-sale terminal, a kiosk, a fuel dispenser interface, etc.), a utility device (e.g., a smart meter gateway, a water treatment control station, a power grid monitoring station, a wind turbine control interface, an energy management system (EMS), etc.), transportation or infrastructure device (e.g., traffic management system, train signal control station, pipeline monitoring system, parking system controller, irrigation system controller, etc.), or other computing device.

The endpoint device 105 includes the hardware 150, which includes one or more processing units 152, one or more memory units 154, and one or more input/output (I/O) devices 156. The one or more processing units 152 may include one or more central processing units (CPUs), one or more graphics processing units (GPUs), one or more neural processing units (NPUs), one or more tensor processing units (TPUs), and/or one or more field-programmable gate arrays (FPGAs). The one or more memory units 154 may include volatile memory such as Random Access Memory (RAM) (e.g., SRAM, DRAM, SDRAM, and/or DDR SDRAM). The one or more I/O devices 156 may include non-volatile memory such as a magnetic disk, a solid-state drive (SSD), a removable drive (e.g., a USB drive), a floppy disk drive, an optical disk drive, network components for wired or wireless communication (e.g., a network interface card, Ethernet adapter or circuitry, a WiFi adapter or circuitry, a modem, a Fieldbus interface, a Fieldbus Adapter, and/or a Fieldbus controller), and/or one or more human interface devices. The one or more I/O devices 156 may also include one or more I/O interfaces (e.g., USB, SATA, Ethernet) to connect to external I/O devices such as a keyboard, mouse, or external drive.

The endpoint device 105 includes the firmware 158, which includes the Unified Extensible Firmware Interface (UEFI) 159 that is used when booting the host operating system 110 and the virtual machine(s).

The endpoint device 105 includes the host operating system 110. The operating system 110 may be a secure operating system that runs in read-only mode, which prevents write operations. This enhances security, prevents corruption, and ensures stability of the operating system. As an example, the operating system 110 may be a Linux based operating system running in read-only mode.

The operating system 110 includes several components, though not all are shown in FIG. 1 to not obscure understanding of the embodiments described herein. The operating system 110 includes the management client 112, the key manager 114, the disk manager 116, the device manager 118, the virtualization module 120, and the image manager 122.

The management client 112 receives communications from the management server 160 such as policy and configuration for the endpoint device 105 including policy and/or configuration for a managed hypervisor and/or virtual machine. The management client 112 may request this information from the management server 160 (e.g., at boot or login time) and/or the management server 160 may periodically push this information to the management client 112 (e.g., upon a change in the policy or configuration, or at a predefined schedule).

As an example, the management client 112 receives a managed hypervisor deployment configuration profile that specifies deployment configuration for the managed hypervisor 130. This configuration profile includes a location (e.g., a URL) where the managed hypervisor 130 is stored. The management client 112 downloads the managed hypervisor 130 from this source and installs the managed hypervisor 130 on the endpoint device 105.

The management client 112 also receives configuration for the virtual machine from the management server 160. This configuration can include a memory setting (e.g., the maximum memory to be allocated to the virtual machine), a number of virtual CPUs to be allocated to the virtual machine, the location (e.g., URL) of where to download the guest operating system image from an image store, the networking mode for the virtual machine (e.g., isolated, Network Address Translation (NAT), direct, host-only, MacVTap), whether the virtual machine is to automatically start during the startup process of the endpoint device, whether a shortcut to the virtual machine is to be placed on the desktop of the operating system 110, whether a shortcut to the virtual machine is to be placed on the start menu of the operating system 110, and/or whether the virtual machine is to start in kiosk mode where user access is limited to only the guest operating system or application running on the virtual machine. In some implementations, the received configuration may supplement or override selected parameters of a virtual machine configuration that was initially created for the virtual machine. For example, when the virtual machine is initially prepared by an administrator, the administrator may generate a virtual machine configuration including virtual machine parameters and upload the virtual machine configuration and one or more corresponding disk images to deployment infrastructure. At a later time, the management system may create one or more deployment configurations assigned to one or more endpoint devices, where a deployment configuration overrides selected parameters of the virtual machine configuration for the assigned endpoint device or group of endpoint devices.

An isolated networking mode will cause the virtual machine to be disconnected from the host network and external network, making it inaccessible via any network interface. In the isolated networking mode, the virtual machine is only accessible via the guest OS user interface presented via the host OS. A NAT networking mode will cause the virtual machine to share the IP address of the endpoint device via NAT where the managed hypervisor translates network traffic between the virtual machine and external networks. A direct networking mode will cause the virtual machine to be directly connected to the physical network interface of the endpoint device with its own IP address. A host-only networking mode will cause the virtual machine to be connected to a virtual network that includes only the host but is isolated from external networks. A MacVTap networking mode causes the virtual machine to get a virtual interface that is linked to the physical network interface of the endpoint device.

The information received from the management server 160 may also include key information for decrypting a guest operating system image. The management client 112 communicates the image location to the image manager 122, and communicates the key information to the key manager 114. Other configuration parameter(s) may be communicated to the virtualization manager 132.

Although FIG. 1 shows one endpoint device, multiple endpoint devices can be managed by their owner or administrator using the management server 160.

The image manager 122 receives the location for downloading a guest operating system image (e.g., a URL). In the example shown in FIG. 1, the guest operating system image is stored on the image store 170. The URL may be configured by the administrator or owner of the endpoint device(s). The image manager 122 downloads the guest operating system image from the image store 170. The guest operating system image includes the guest operating system. The guest operating system image may be encrypted. The guest operating system image may be in Open Virtualization Format (OVF) or in another format (e.g., a proprietary format). The image manager 122 may verify the integrity of the downloaded guest operating system image (e.g., through a comparison of a checksum calculated from the downloaded image with a checksum provided in the downloaded package). If the integrity of the downloaded image is not verified, an error will occur. The image manager 122 stores the guest operating system image (e.g., the encrypted image) on a persistent disk partition (e.g., one of the I/O device(s) 156) of the endpoint device 105. This disk partition is dedicated for guest operating system image deployment. If the downloaded guest operating system image is encrypted, the key manager 114 decrypts the image. The encryption key may be a symmetric key that is unique to each guest operating system image.

A secure boot process is used to load the virtual machine within the managed hypervisor. For example, the virtual machine can access the UEFI 159 of the firmware 158 to start the boot process within the managed hypervisor 130. The virtual machine verifies the signature of the bootloader against the secure boot keys. If the signature is missing or invalid the boot process stops.

The managed hypervisor 130 uses type 1 kernel components to run directly within the kernel to provide, among other things, direct hardware access and acceleration. This is provided through the virtualization module 120. The managed hypervisor uses type 2 client-based components that leverage the type 1 components (provided by the virtualization module 120) for hardware and platform compatibility, and hardware acceleration for performance enhancements. The type 2 client-based components are used to interact with a virtual machine and provide a visualization layer. The type 2 client-based components are provided through the virtualization manager 132 and the emulator 134.

The virtualization manager 132 manages the virtual machine(s) including starting and stopping the virtual machines. The virtualization manager 132 can receive management instructions from the management client 112 that receives the management instructions from the management server 160. For example, the management client 112 can receive an instruction from the management server 160 to start a virtual machine, stop a virtual machine, or reboot a virtual machine. The virtualization manager 132 instructs the emulator 134 to start a virtual machine, stop a virtual machine, or reboot a virtual machine.

The emulator 134 creates the virtual machine according to the instructions received from the virtualization manager 132, sets up virtual hardware, and loads the guest operating system. The emulator 134 may interact with the disk manager 116, the device manager 118, and the virtualization module 120 when creating the virtual machine and setting up virtual hardware.

The device manager 118 dynamically creates and manages device nodes when hardware or virtual devices are detected. The device manager 118 may listen for kernel events that are sent when hardware is added, removed, or modified (e.g., plugging a USB drive or initializing a virtual device). It then can create device nodes, set permissions, or trigger actions to make devices accessible to the emulator 134.

The emulator 134 may read a device file created by the device manager 118 when the virtualization module 120 is loaded. This device file acts as an interface to the virtualization module to allow the emulator 134 to create and manage virtual machines using hardware virtualization extensions provided through the virtualization module 120. For instance, the emulator 134 can use this interface to manage a virtual machine such as setting up the address space, managing memory, and controlling hardware such as a virtual CPU. Further, the emulator 134 can use this interface to start, stop, pause, and resume a virtual machine. Thus, CPU and memory virtualization is offloaded to the virtualization module 120 instead of being emulated in software. Thus, the virtualization module 120 executes the guest CPU code efficiently via hardware utilization.

The disk manager 116 abstracts physical storage of the endpoint device 105 into a logical storage system. The emulator 134 creates and uses a copy-on-write snapshot volume in memory (e.g., a volatile memory of one of the memory unit(s) 154 and/or a non-volatile memory of one of the I/O device(s) 156). In one embodiment, write operations redirected to the copy-on-write snapshot volume are not retained after a shutdown of the endpoint device 105, the managed hypervisor 130, or the virtual machine. In another embodiment, the write operations redirected to the copy-on-write snapshot volume are retained after a shutdown of the endpoint device 105, the managed hypervisor 130, or the virtual machine. For instance, the data can be persisted to a non-volatile storage device of the endpoint device 105.

There can be one or more virtual machines that are created. For instance, as shown in FIG. 1, the virtual machines 140A-N are created that execute the guest operating systems 142A-N respectively. The emulator 134 provides the virtualization layer for the virtual machine(s). The emulator 134 can support full function mode or kiosk mode. In full function mode, the virtual machine and the host operating system 110 are both accessible by the user of the endpoint device 105. In kiosk mode, only the guest operating system of the virtual machine is accessible by the user of the endpoint device 105.

The adaptive security control 125, which is optional in some embodiments, may provide security for the managed hypervisor 130. The adaptive security control 125 may apply policies such as firewall policies, which can be configured by a customer using the management server 160 and applied to the endpoint device 105. For example, a firewall policy may be defined to block or allow incoming traffic not related to any existing connection of a guest OS. As another example, a firewall policy may be defined to block outgoing traffic with possible exceptions through allowed ports or protocols. As another example, a policy may be defined to force traffic through a VPN.

Thus, FIG. 1 shows a system for deploying and managing virtual machines for endpoint devices. This system provides several benefits, including the ability to abstract and secure legacy operating systems where hardware compatibility and driver support are unavailable for newer hardware platforms. In addition, it helps eliminate the need to maintain expensive legacy hardware that has limited support and replacement options. Further, the system can effectively create an immutable, read only version of an insecure operating system with the ability to reset to a known good state.

The following describes one implementation of the endpoint device 105. In this example implementation, the endpoint device 105 may be running a Linux operating system as the operating system 110 in read-only mode, the virtualization manager 132 may be a modified libvirt component, the emulator 134 may be Quick Emulator (QEMU), and the virtualization module 120 may be Kernel-based Virtual Machine (KVM).

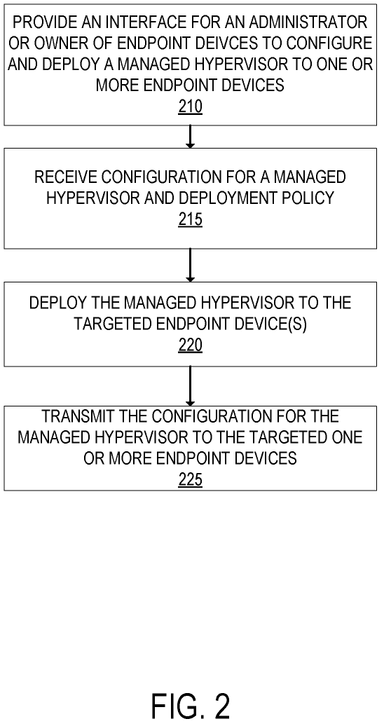

FIG. 2 illustrates a flow diagram for configuring and deploying a managed hypervisor according to an embodiment. The operations of FIG. 2 are described with respect to the exemplary embodiment of FIG. 1. However, the operations of FIG. 2 can be performed by different embodiments from that of FIG. 1, and the exemplary embodiment of FIG. 1 can perform operations different from that of FIG. 2.

At operation 210, an interface is provided on the management server 160 for an administrator or owner of endpoint devices to configure and deploy a managed hypervisor and guest operating system(s) to one or more of their endpoint devices. This interface allows the administrator or owner to configure a managed hypervisor (or multiple managed hypervisors) and deploy the managed hypervisor to a specific endpoint device or to group(s) of endpoint devices. The parameters that can be configured may include: a name of the managed hypervisor, memory parameter(s) (e.g., the maximum amount of memory allocated to the virtual machine), whether the managed hypervisor automatically starts during the boot of the endpoint device 105, the location (e.g., the URL) of where to download the guest operating system image, the networking mode for the virtual machine, whether the virtual machine is to automatically start during the startup process of the endpoint device 105, whether a shortcut to the virtual machine is to be placed on the desktop of the operating system 110, whether a shortcut to the virtual machine is to be placed on the start menu of the operating system 110, and/or whether the virtual machine is to start in kiosk mode where user access is limited to only the guest operating system or application running on the virtual machine. The interface allows the administrator or owner to deploy a configured managed hypervisor to a specific endpoint device or to a group of endpoint devices.

At operation 215, the interface on the management server 160 receives configuration for a managed hypervisor and instructions for deploying the managed hypervisor to one or more endpoint devices. In this example, the endpoint device 105 has been targeted for the deployment of the managed hypervisor. The configuration is stored on the management server 160. As an example, the management server 160 may assign a configuration profile to the endpoint device(s) that has been targeted to run the managed hypervisor (e.g., the endpoint device 105).

The management server 160 associates the endpoint devices that are assigned to a deployment policy and associated configuration for a particular managed hypervisor. For example, a unique identifier associated with an endpoint device can be associated with the deployment policy and associated configuration. As another example, a group identifier that identifies a group of endpoint devices, each having their own unique device identifier, can be associated with the deployment policy and associated configuration.

At operation 220, the managed hypervisor is deployed to the targeted one or more endpoint devices. For example, the management server 160 (or other deployment server of the service) transmits the managed hypervisor to the targeted endpoint device(s). For example, the management server 160 may receive a request from the endpoint device 105 for a configuration profile for the managed hypervisor (e.g., sent at boot or login of the endpoint device 105, or at another sync interval). The management server 160 accesses the managed hypervisor deployment data to determine what, if any, configuration profile is applicable to the endpoint device 105 (e.g., based on the unique identifier of the endpoint device 105 and/or a group identifier of a group to which the endpoint device 105 belongs). The management server 160 transmits the configuration profile to the targeted endpoint device(s), which includes a location (e.g., URL) to download the managed hypervisor. The management client 112 receives the configuration profile from the management server 160 and causes the managed hypervisor to be downloaded from the source specified in the configuration profile. The management client 112 will cause the managed hypervisor to be installed on the endpoint device 105. The management server 160 may also transmit key information to the endpoint device 105 for decrypting the corresponding guest operating system image.

At operation 225, the configuration for the managed hypervisor is transmitted to the targeted one or more endpoint devices. For example, the management server 160 may receive a request from the endpoint device 105 for the configuration for the managed hypervisor (e.g., upon the installation of the managed hypervisor, upon boot or login, or at another sync interval). The management server 160 accesses the managed hypervisor deployment data to determine what, if any, configuration is applicable to the endpoint device 105 (e.g., based on the unique identifier of the endpoint device 105 and/or a group identifier of a group to which the endpoint device 105 belongs). The management server 160 transmits the applicable managed hypervisor configuration to the endpoint device 105. As another example, the management server 160 may periodically push the managed configuration information to the endpoint device 105 (e.g., upon a change in the policy or configuration, or at a predefined schedule).

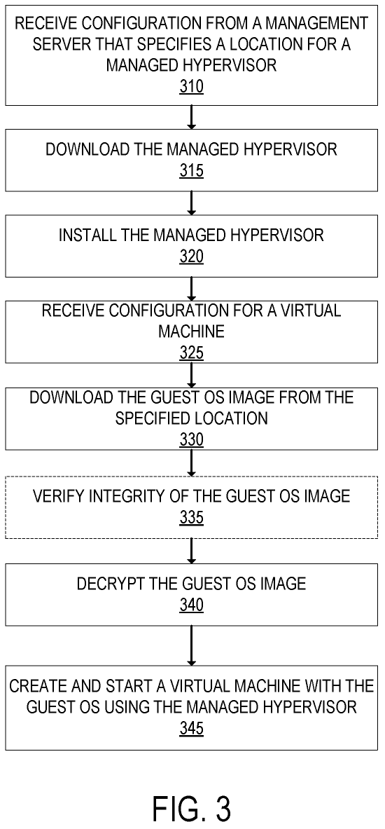

FIG. 3 is a flow diagram that illustrates exemplary operations performed at an endpoint device for executing a managed hypervisor according to an embodiment. The operations of FIG. 3 are described with respect to the exemplary embodiment of FIG. 1. However, the operations of FIG. 3 can be performed by different embodiments from that of FIG. 1, and the exemplary embodiment of FIG. 1 can perform operations different from that of FIG. 3.

At operation 310, the management client 112 receives configuration from the management server 160 regarding deployment of the managed hypervisor 130. The configuration specifies a location (e.g., a URL) of the managed hypervisor 130. The management client 112 may request this information from the management server 160 (e.g., at boot or login time of the endpoint device 105 or other sync interval). The management server 160 may communicate this information because of an owner or administrator of the endpoint device 105 configuring the deployment of the managed hypervisor to the endpoint device 105.

At operation 315, the management client 112 downloads the managed hypervisor 130 from the source specified in the received configuration. The source may be the management server 160 or other deployment server. The managed hypervisor may be cryptographically signed, and the management client 112 may verify the signature prior to installation. If the signature is not valid, an error may be returned.

At operation 320, the managed hypervisor 130 is installed on the endpoint device 105 and loaded. The managed hypervisor 130 operates as a hybrid hypervisor that uses type 1 (bare metal) and type 2 (hosted) components. The managed hypervisor uses type 1 kernel components to run directly within the kernel of the operating system 110 to provide, among other things, direct hardware access and acceleration. The managed hypervisor uses type 2 client-based components that leverage the type 1 components for hardware and platform compatibility, and hardware acceleration for performance enhancements. The type 2 client-based components are used to interact with a virtual machine and provide a visualization layer. The type 1 components are provided through the virtualization module 120. The type 2 components are provided through the virtualization manager 132 and the emulator 134.

At operation 325, the management client 112 receives configuration for a virtual machine from the management server 160. The management client 112 may request this information from the management server 160 (e.g., at boot or login time of the endpoint device 105) and/or the management server 160 may periodically push this information to the management client 112. The configuration may include a location (e.g., a URL) of a guest operating system image, a number of virtual CPUs to be allocated to the virtual machine, a memory setting (e.g., the maximum memory to be allocated to the virtual machine), the networking mode for the virtual machine (e.g., isolated, Network Address Translation (NAT), direct, host-only, MacVTap), whether the virtual machine is to automatically start during the startup process of the endpoint device, whether a shortcut to the virtual machine is to be placed on the desktop of the host operating system, whether a shortcut to the virtual machine is to be placed on the start menu of the host operating system, and/or whether the virtual machine is to start in kiosk mode where user access is limited to only the guest operating system or application running on the virtual machine. The configuration may include key information for decrypting an encrypted guest operating system image. The image location is communicated to the image manager 122. The key information is communicated to the key manager 114. The management server 160 may communicate this information because of an owner or administrator of the endpoint device 105 configuring the managed hypervisor.

At operation 330, the image manager 122 downloads the guest operating system image from the specified location (e.g., the image store 170). The guest operating system image includes the guest operating system. The guest operating system image may be encrypted. At operation 335, which is optional in some embodiments, the image manager 122 verifies the integrity of the guest operating system image. For example, the image manager 122 compares a checksum calculated from the downloaded guest operating system image with a checksum provided in the downloaded package. If the integrity of the downloaded image is not verified, an error will occur. The operations in FIG. 3 assume that the integrity of the downloaded image is verified. The image manager 122 may store the guest operating system image (e.g., the encrypted image) on a persistent disk partition on persistent storage of the endpoint device 105.

At operation 340, the key manager 114 decrypts the guest operating system image. The encryption key may be a symmetric key that is unique to each guest operating system image that is communicated from the management server 160.

At operation 345, a virtual machine with a guest OS is created and started using the managed hypervisor 130. For example, the emulator 134 creates the virtual machine according to the instructions received from the virtualization manager 132, sets up virtual hardware, and loads the guest operating system. The emulator 134 may interact with the disk manager 116, the device manager 118, and the virtualization module 120 when creating the virtual machine and setting up virtual hardware. When running, writes by the guest operating system may be redirected to a data structure in memory of the endpoint device 105 such as one of the volatile memory unit(s) 154 and/or one of the I/O device(s) 156. If the endpoint device 105, the managed hypervisor 130, or the virtual machine is shut down, the writes are discarded in an embodiment. Although FIG. 3 shows an embodiment where the writes in the data structure in volatile memory unit 154 are discarded, in another embodiment the writes in the data structure in memory can be retained in persistent storage of the endpoint device 105 upon a shutdown.

The managed hypervisor 130 can be centrally managed. The management client 112 can receive instructions or updated configuration from the management server 160 to control the virtual machine(s) on the endpoint device 105. For instance, an instruction may be to start the managed hypervisor 130 and/or to start a particular virtual machine. As another example, an instruction may be to shut down the managed hypervisor 130 and/or to shut down a particular virtual machine. As another example, an instruction may be to reboot the managed hypervisor 130 and/or to reboot a particular virtual machine. The management client 112 communicates such an instruction to the virtualization manager 132, which then instructs the emulator 134 to take the appropriate action (e.g., start a VM, stop a VM, reboot a VM).

As another example, the management client 112 can receive an updated configuration for the managed hypervisor 130. For instance, this could be a change in the networking mode, a change to whether the virtual machine is to be in kiosk mode, or other update. The management client 112 communicates such a configuration change to the virtualization manager 132 to make the configuration change. The virtualization manager 132 may instruct the emulator 134 to take the appropriate action, which may require restarting the virtual machine to take effect.

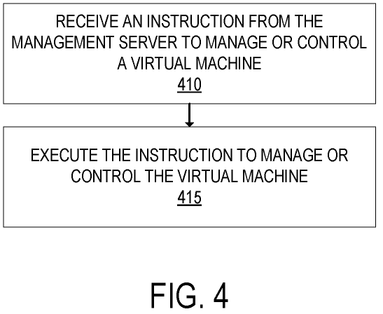

FIG. 4 is a flow diagram that illustrates exemplary operations performed at an endpoint device for responding to instructions to manage a virtual machine according to an embodiment. The operations of FIG. 4 are described with respect to the exemplary embodiment of FIG. 1. However, the operations of FIG. 4 can be performed by different embodiments from that of FIG. 1, and the exemplary embodiment of FIG. 1 can perform operations different from that of FIG. 4.

At operation 410, the management client 112 of the operating system 110 of the endpoint device 105 receives an instruction from the management server 160 to manage or control a virtual machine. The management client 112 communicates the instruction to the virtualization manager 132 to manage the execution of the instruction. The instruction to manage or control the virtual machine is executed at operation 415. For example, the virtualization manager 132 instructs the emulator 134 to perform the instruction.

As an example instruction, if the instruction is to shut down a virtual machine, the virtualization manager 132 instructs the emulator 134 to shut down the virtual machine, and the emulator 134 shuts down the virtual machine. In an embodiment where writes by the guest operating system are redirected to a data structure in memory and discarded on a shutdown or reboot, shutting down the virtual machine causes those writes to be discarded. The virtual machine is then started using the managed hypervisor 130 from the base guest operating system image. In an embodiment where writes by the guest operating system are to be persisted on a shutdown or reboot, shutting the virtual machine down causes those writes in the data structure in memory to be persisted. For example, if the snapshot volume is originally on volatile memory, the snapshot volume is written to persistent storage of the endpoint device 105 and the data is persisted. As another example, if the snapshot volume is written to non-volatile memory, the endpoint device is configured to retain the data upon a shutdown. In such an embodiment, the virtual machine is started using the managed hypervisor 130 from the image and the snapshot volume.

The management client 112 can also receive an instruction to reboot or shutdown the endpoint device 105 itself. In such a case, the management client 112 causes the operating system 110 to reboot or shutdown as instructed. In an embodiment where writes by the guest operating system are redirected to a data structure in memory and discarded on a shutdown or reboot, shutting down or rebooting the endpoint device 105 causes those writes to be discarded. In an embodiment where writes by the guest operating system are to be persisted on a shutdown or reboot, shutting down or rebooting the endpoint device 105 causes those writes in the data structure in memory to be persisted like as described above In such an embodiment, the virtual machine is started using the managed hypervisor 130 from the image and the snapshot volume.

The techniques shown in the figures can be implemented using code and data stored and executed on one or more computing devices. Such computing devices store and communicate (internally and/or with other computing devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such computing devices typically include a set of one or more hardware processors coupled to one or more other components, such as one or more I/O devices (e.g., storage devices (non-transitory machine-readable storage media), a keyboard, a touchscreen, a display, and/or network connections). The coupling of the set of processors and other components is typically through one or more busses and bridges (also termed as bus controllers). Thus, the storage device of a given computing device typically stores code and/or data for execution on the set of one or more processors of that computing device.

In the preceding description, numerous specific details are set forth to provide a more thorough understanding. It will be appreciated, however, by one skilled in the art that embodiments may be practiced without such specific details. In other instances, control structures, gate level circuits and full software instruction sequences have not been shown in detail in order not to obscure understanding. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method performed in an endpoint device, comprising:
receiving managed hypervisor deployment configuration from a management server that specifies a first location to download a managed hypervisor;
downloading the managed hypervisor from the specified first location;
installing and loading the managed hypervisor on the endpoint device, wherein the managed hypervisor uses type 1 kernel components to provide direct hardware access and acceleration and uses type 2 client-based components to interact with a virtual machine and provide a visualization layer, wherein the type 2 client-based components leverage the type 1 kernel components for hardware and platform compatibility and hardware acceleration for performance enhancements;
receiving virtual machine configuration for a virtual machine from the management server, wherein the virtual machine configuration specifies a second location to download a guest operating system image;
downloading the guest operating system image from the specified second location, wherein the guest operating system image is encrypted;
decrypting the guest operating system image, wherein the decrypted guest operating system image includes a guest operating system; and
creating and starting the virtual machine with the guest operating system using the managed hypervisor, wherein writes by the guest operating system are redirected to a data structure in memory of the endpoint device.

2. The method of claim 1, wherein the encrypted guest operating system image is stored in a partition of persistent storage of the endpoint device that is dedicated for encrypted guest operating system image storage.

3. The method of claim 1, further comprising:
receiving an instruction from the management server to shut down the virtual machine;
shutting down the virtual machine, wherein shutting down the virtual machine causes the writes by the guest operating system in the memory to be discarded; and
starting the virtual machine with the guest operating system, wherein the guest operating system starts using the guest operating system image.

4. The method of claim 1, wherein the virtual machine configuration further specifies whether the guest operating system operates in kiosk mode.

5. The method of claim 1, wherein the virtual machine configuration further specifies access restrictions.

6. The method of claim 1, further comprising: verifying integrity of the downloaded guest operating system image prior to loading the guest operating system.

7. An endpoint device, comprising:
a processing system;
a memory; and
a non-transitory machine-readable storage medium to store a host operating system and a guest operating system image, wherein the host operating system when executed, includes a management client and an image manager,
wherein the management client downloads a managed hypervisor from a management server and causes the managed hypervisor to be installed and loaded on the endpoint device, wherein the managed hypervisor uses type 1 kernel components to provide direct hardware access and acceleration and uses type 2 client-based components to interact with a virtual machine and provide a visualization layer, wherein the type 2 client-based components leverage the type 1 kernel components for hardware and platform compatibility and hardware acceleration for performance enhancements,
wherein the management client receives virtual machine configuration from the management server that specifies a location for the guest operating system image,
wherein the image manager downloads the guest operating system image from the specified location, and
wherein the managed hypervisor creates and starts the virtual machine with the guest operating system, wherein writes by the guest operating system are redirected to a data structure in the memory.

8. The endpoint device of claim 7, wherein the guest operating system image is encrypted, wherein the host operating system further includes a key manager to decrypt the guest operating system image with a key received from the management server.

9. The endpoint device of claim 7, wherein the guest operating system image is to be stored in a dedicated partition of the non-transitory machine-readable storage medium.

10. The endpoint device of claim 7, wherein the management client receives an instruction from the management server to control the virtual machine, wherein the instruction is one or more of reboot the virtual machine and shutdown the virtual machine, wherein the management client causes the virtual machine to be reboot or shutdown depending on the instruction, wherein rebooting or shutting down the virtual machine causes the writes by the guest operating system in the memory to be discarded, and wherein the managed hypervisor creates and starts the virtual machine with the guest operating system of the guest operating system image.

11. The endpoint device of claim 7, wherein the virtual machine configuration further specifies whether the guest operating system operates in kiosk mode.

12. The endpoint device of claim 7, wherein the virtual machine configuration further specifies access restrictions.

13. The endpoint device of claim 7, wherein the image manager further verifies integrity of the downloaded guest operating system prior to starting the virtual machine.

14. A non-transitory machine-readable storage medium that provides instructions that, if executed by a processing system of an endpoint device, will cause said endpoint device to perform operations comprising:
receiving managed hypervisor deployment configuration from a management server that specifies a first location to download a managed hypervisor;
downloading the managed hypervisor from the specified first location;
installing and loading the managed hypervisor on the endpoint device, wherein the managed hypervisor uses type 1 kernel components to provide direct hardware access and acceleration and uses type 2 client-based components to interact with a virtual machine and provide a visualization layer, wherein the type 2 client-based components leverage the type 1 kernel components for hardware and platform compatibility and hardware acceleration for performance enhancements;
receiving virtual machine configuration for a virtual machine from the management server, wherein the virtual machine configuration specifies a second location to download a guest operating system image;
downloading the guest operating system image from the specified second location, wherein the guest operating system image is encrypted;
decrypting the guest operating system image, wherein the decrypted guest operating system image includes a guest operating system; and
creating and starting the virtual machine with the guest operating system using the managed hypervisor, wherein writes by the guest operating system are redirected to a data structure in memory of the endpoint device.

15. The non-transitory machine-readable storage medium of claim 14, wherein the encrypted guest operating system image is stored in a partition of persistent storage of the endpoint device that is dedicated for encrypted guest operating system image storage.

16. The non-transitory machine-readable storage medium of claims 14, wherein the operations further include:
receiving an instruction from the management server to shutdown the virtual machine;
shutting down the virtual machine, wherein shutting down the virtual machine causes the writes by the guest operating system in the memory to be discarded; and
starting the virtual machine with the guest operating system, wherein the guest operating system starts using the guest operating system image.

17. The non-transitory machine-readable storage medium of claim 14, wherein the virtual machine configuration further specifies whether the guest operating system operates in kiosk mode.

18. The non-transitory machine-readable storage medium of claim 14, wherein the virtual machine configuration further specifies access restrictions.

19. The non-transitory machine-readable storage medium of claim 14, further comprising:
verifying integrity of the downloaded guest operating system image prior to loading the guest operating system.
